(19) United States
(12) Patent Application Publication
(10) Pub. No.: US 2010/0076923 A1
(43) Pub. Date: Mar. 25, 2010

(54) ONLINE MULTI-LABEL ACTIVE ANNOTATION OF DATA FILES

(75) Inventors: Xian-Sheng Hua, Beijing (CN); Guo-Jun Qi, Hefei (CN); Shipeng Li, Palo Alto, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/238,290

(22) Filed: Sep. 25, 2008

(51) Int. Cl. G06F 15/18; G06Q 30/00

(52) U.S. Cl. 706/61

(57) ABSTRACT

Online multi-label active annotation may include building a preliminary classifier from a pre-labeled training set included with an initial batch of annotated data samples, and selecting a first batch of sample-label pairs from the initial batch of annotated data samples. The sample-label pairs may be selected by using a sample-label pair selection module. The first batch of sample-label pairs may be provided to online participants to manually annotate the first batch of sample-label pairs based on the preliminary classifier. The preliminary classifier may be updated to form a first updated classifier based on an outcome of the providing the first batch of sample-label pairs to the online participants.

### BACKGROUND

Digital video files can be digitally labeled to facilitate search. However, digital video files are difficult to label. For example videos may be labeled using “direct text”. Direct text may be for example, surrounding text, video description, or video metadata. Surrounding text may be the text in a webpage that may be related to the video. Video descriptions may be, for example, the textual description of the target video, including title, author, content description, tags, comments, etc. Video metadata may be, for example, format, bitrates, frame size, etc. However, direct text frequently does not accurately portray the real content of the video.

### SUMMARY

Online multi-label active annotation is disclosed. The online multi-label active annotation may include building a preliminary classifier from a pre-labeled training set included with an initial batch of annotated data samples. It may also include selecting a first batch of sample-label pairs from the initial batch of annotated data samples. The sample-label pairs may be selected by using a sample-label pair selection module. The first batch of sample-label pairs may be provided to online participants to manually annotate the first batch of sample-label pairs based on the preliminary classifier. The preliminary classifier may be updated to form a first updated classifier based on an outcome of providing the first batch of sample-label pairs to the online participants.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view illustrating an example system for annotating multiple data samples with multiple labels.

FIG. 2 is a schematic view illustrating an example workflow for annotating multiple data samples with multiple labels.

FIGS. 3 through 12 are flowcharts illustrating various methods for annotating multiple data samples with multiple labels.

### DETAILED DESCRIPTION

Online multi-label active annotation of data files in accordance with the present disclosure may provide a scalable framework for annotating video files. The scalability of the framework may extend to the number of concept labels and to the number of video samples that can be annotated using techniques disclosed herein. Thus, very large scale annotation operations may be accomplished.

Embodiments may use machine learning techniques that may be performed using a computing device. The computing device may be first taught how to perform the annotation. After sufficient learning, samples may be categorized in accordance with one or more potential labels. To categorize a sample, the sample may be input into the computing machine having a classification function, and the computing machine may then output a label for the sample.

Supervised learning is a machine learning technique for creating a classification function from a training set. The training set may include multiple samples with labels that are already categorized. After training with the labeled samples, the machine can accept a new sample and produce a label for the new sample without user interaction.

Creating the training data may include user interaction. To decrease this time and expense, active learning may be employed. Active learning is a technique in which a human may manually label a subset of the training data samples. Active learning may include carefully selecting which samples are to be labeled so that the total number of samples that may need to be labeled in order to adequately train the machine is decreased. The reduced labeling effort can therefore save significant time and expense as compared to labeling all of the possible training samples.

Using the framework disclosed herein, large-scale unlabeled video samples may arrive consecutively in batches with an initial pre-labeled training set as the first batch. A preliminary multi-label classifier may be built from the initial pre-labeled training set. For each arrived batch, an online multi-label active learning engine may be applied to efficiently update the classifier, which may improve the performance of the classifier on all currently-available data. This process may repeat until all data have arrived and may resume when a new data batch is available. New concept labels may be allowed to be introduced into the online multi-label active learning framework at any batch, even though these labels may have no pre-labeled training samples.

The core approach, of online multi-label active learning (Online MLAL), according to the disclosure, may include three major modules, multi-label active learning, online multi-label learning and new label learning.

Multi-label active learning may save labeling cost by exploiting the redundancy in samples. Some embodiments may exploit the redundancy both in samples and semantic labels. Some embodiments may iteratively request one or two groups of editors to confirm the labels of a selected set of sample-label pairs to minimize an estimated classification error. This may be more effective than using samples with all labels.

The online multi-label learning disclosed herein may reduce the computational cost in multi-label active learning. The online multi-label learning disclosed herein may be able to incrementally update the multi-label classifier by adapting the original classifier to the newly labeled data. Different from other possible learning approaches, the approach disclosed herein may exploit the correlations among multiple labels to improve the performance of the classifier.

New label learning disclosed herein may make the proposed framework scalable to new semantic labels. Existing semantic annotation schemes may only be applicable for a closed concept set. This may not be practical for real-world video search engines. The online learner disclosed herein may be effectively extended to handling new labels, even though these new labels may have no pre-labeled training data. The annotation performance of the new labels may be gradually improved through the iterative active learning process. In some embodiments, the new label learning may be from zero-knowledge.

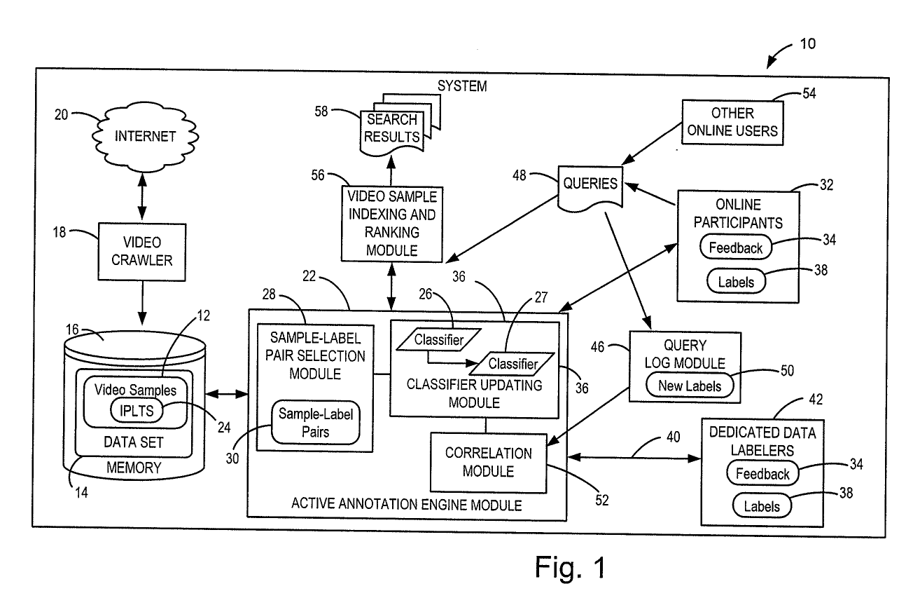

FIG. 1 illustrates a system 10 for online multi-label active annotation. The system 10 may include a collection of video samples 12, included in a dataset 14 that may be saved in a memory 16. The video samples 12 in the dataset 14 may be acquired various ways, for example through data transfer, or through use of a video crawler 18 that may be configured to browse the Internet 20 in a methodical, automated manner to locate video samples 12, and to download them to the memory 16. The memory 16 may be coupled with an active annotation engine module 22. It will be understood that other type of data files, not just video samples 12 may be used in other embodiments.

The video samples 12 may include an initial batch of videos that may include an initial pre-labeled training set 24 (IPLTS) configured to be used by the active annotation engine module 22 to build a preliminary classifier 26.

The active annotation engine module 22 may include a sample-label pair selection module 28 that may be configured to select a first batch of sample-label pairs 30 from the collection of video samples 12. The sample-label pair selection module 28 may be configured to select sample-label pairs (xₛ*, yₛ*) for annotation as described below. The sample-label pair selection process may be configured to, for example, minimize an expected classification error.

The active annotation engine module 22 may also be coupled with online participants 32 to make the first batch of sample-label pairs 30 available to the online participants to enable the online participants 32 to provide feedback 34 to the active annotation engine module 22. The feedback 34 may be used for confirming or rejecting an appropriateness of pairings of the sample-label pairs 30. The feedback 34 may be configured to update the preliminary classifier 26 to form an updated classifier 27 such that the updated classifier 27 may be used to annotate subsequent batches of video samples 12. A classifier updating module 36 may be configured to receive the feedback 34 to effect the updating of the preliminary classifier 26 to the updated classifier 27. The online participants 32 may provide labels 38 for the video samples 12. The feedback 34 may be in the form of labels 38.

The active annotation engine module 22 may be further configured to iteratively select subsequent sample-label pairs 30 from the subsequent batches of video samples 12, and to provide the subsequent sample-label pairs 30 to the online participants 32 to enable the online participants 32 to provide feedback 34 to the active annotation engine module 22 confirming or rejecting an appropriateness of pairings of the subsequent sample-label pairs 30. The feedback 34 may be configured to iteratively update the preliminary classifier 26 to form a subsequently updated classifier 27 such that the subsequently updated classifier 27 is used to annotate subsequent batches of video samples 12. The preliminary classifier 26 and the updated classifier 27 may be configured to provide automated annotation of the video samples 12.

The system may include a data connection 40 between the active annotation engine module 22 and one or more dedicated data labelers 42, and may be configured to enable the one or more dedicated data labelers 42 to provide additional annotation, for example labels 38 for the video samples 12. The dedicated data labelers 42 may instead, or in addition, provide feedback 34 to the active annotation engine module 22 that may be configured to confirm or reject the accuracy and/or appropriateness of at least some of the automatic annotation done using the updated classifier 27.

The system 10 may also include a query log module 46 that may be configured to capture query criteria from queries 48 used by the online participants 32. The system 10 may be configured to use the query criteria to create one or more new labels 50 to be used by the active annotation engine module 22. A correlation module 52 may be configured to compare the new label 50 to other labels 38 previously used to annotate the video samples 12. The correlation module 52 may be further configured to use the new label 50 only if a level of correlation between the new label 50, and at least one previously used label 38, is above a predetermined threshold. Queries from other online users 54, besides the online participants 32, may also be used to create new labels 50. The frequency of a term appearing in queries 48 may also affect whether or not the term is used as a new label 50. For example, a new term may be learned if it is frequently used by users as a query term but it is not well indexed.

The correlation module 52 may be configured to model the correlations among multiple labels, multiple instances, multiple modalities and multiple graphs. The correlation module 52 may also be configured to utilize the relationships among different labels, or instances, etc., and the correlations among instance, labels, modalities and graphs.

The system 10 may also include a video sample indexing and ranking module 56 that may be configured to collect the results of annotation performed by the system 10. The results may be modified, for example, by indexing the results and ranking the results by relevance according to predetermined criteria. The online participants 32 and/or the dedicated data labelers 42 may be asked to confirm annotations or rankings of certain videos or video segments, which may have been automatically selected by the active annotation engine module 22.

The contributions of the online participants 32 may not only be applied passively (such as using tags, comments, and click-through), but may also be used actively. Based on this back-end analysis, search results 58 may be actively presented and may be used to collect users' contribution in annotating video data.

In various use scenarios the active annotation engine module 22 may parse the video and extract “direct text” metadata and low-level features and/or perform other initial analysis of the video. After analyzing, the active annotation engine module 22 may select a set of videos and ask the online participants 32 and/or the dedicated data labelers 42 to confirm semantic labels. After labeling, the system 10 may do further analysis and annotate the rest of the new dataset 14, and may also update the labels of old video data. At the same time, active annotation engine module 22 may further suggest a set of videos for an editor, for example, online participants 32 and/or the dedicated data labelers 42, to do manual annotating. This process may be continuous.

The active annotation engine module 22 may also select a set of samples from indexed videos and may request that online participants 32 and/or the dedicated data labelers 42 confirm the labels, which will be used to refine the annotation accuracy. This may also be a continuous process, thus the annotation accuracy may be continuously improved.

From query analysis, a new term may need to be annotated. The active annotation engine module 22 may then automatically analyze the correlation of this new term with existing terms and “direct text” metadata, and then select a set of videos and ask editors, for example the online participants 32 and/or the dedicated data labelers 42, to confirm the labels. The process may be repeated.

The active annotation engine module 22 may return ranked search results according to users' queries, and the system 10 may track users' behaviors on these results, such as clicked items and playing time, to assess the quality of the labeling and the search results. The system 10 may also provide an interface for users to input comments and/or tags for the search results. The information collected may be applied in the active annotation process at the backend.

As a result of a backend analysis, the system 10 may collect predetermined categories of information from the online participants 32 and/or the dedicated data labelers 42. Then the system 10 may present the search results in a different manner, including a different ranking scheme. This may be done in a non-intrusive way, by, for example, inviting users to input feedback, providing games or interactions or additional information to users based on the search results, etc. The information obtained may be integrated into the active annotating process at the backend.

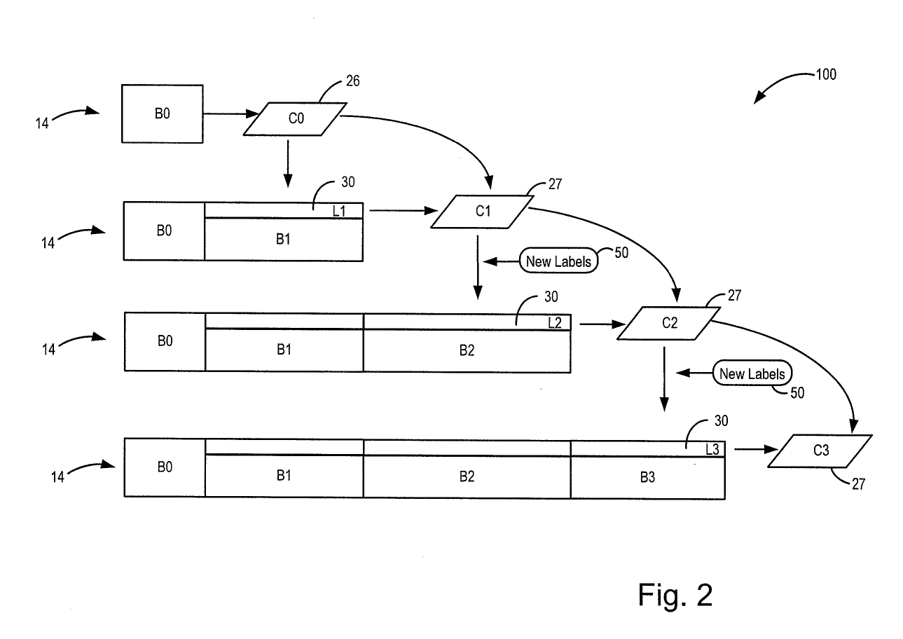

FIG. 2 is a schematic view illustrating one example work flow 100 showing how an entire video dataset 14 may be annotated with online active learning according to various embodiments. The work flow 100 may be performed utilizing one or more computing devices, and one or more networks, such as the Internet 20.

The work flow 100 may include a number of iterations. Data may be received in batches, denoted by B0, B1, B2 . . . , etc. Each iteration may increase the size of the dataset 14. The dataset 14 may also increase in size, as mentioned above, due to continuous data sample crawling. The data samples may be for example video samples, or still image samples, or the like. A portion of each batch B0, B1, B2 . . . , etc. may be actively labeled during active learning. The actively labeled portions are denoted as L1, L2, L3 . . . , etc. and each may include the sample-label pairs 30. A batch with n samples and m semantic concepts will have m×n sample-label pairs. B0 denotes the initial pre-labeled training set. The preliminary classifier 26 is denoted by C0. Updated classifiers 27 are denoted by C1, C2 . . . , etc. New labels 50 are illustrated as being introduced, for example, to be included as part of the actively labeled data during active learning. The learning procedure of the online multi-label active learning approach according to the embodiments may be summarized as follows.

Active Learning on (B0+B1). Based on the knowledge in preliminary classifier 26, an iterative multi-label active learning process may be applied on B1. In each round, a certain number of sample-label pairs 30 may be selected to be annotated manually, and an updated classifier 27 may be built through an online learner based on the current classifier and the newly labeled data. The final updated classifier 27 may be gradually built by the online learner based on the preliminary classifier 26 and the sample-label pairs 30.

From the iteration t=2 to N, active learning on (B0+B1+ . . . +Bt). Based on the knowledge in classifier Ct-1, the active learning process may be applied on the set of all available unlabeled sample-pairs. The final classifier may then be built step by step by the online learner using the classifier Ct from the previous iteration and the selected sample-label pairs 30.

Learning New Labels. During any operation described above, the multi-label classifier C1, C2 . . . , etc. can be extended to handle new labels 50, and with the arrival of a next data batch B2, B3 . . . , etc. The new sample-label pair set will cover the new labels 50, and may be selected by the sample-label pair selection module (28 from FIG. 1) in the active annotation engine module (22 from FIG. 1). The correlations between the new labels 50 and existing labels 38 may be gradually exploited with the increase of labeled sample-label pairs 30.

For each arrived batch, a multi-label active learning engine may be applied, which may automatically select and manually annotate each batch of unlabeled sample-label pairs. An online learner may then update the original classifier by taking the newly labeled sample-label pairs into consideration. This process may repeat until all data has arrived. During the process, new labels, even without any pre-labeled training samples, can be incorporated into the process anytime. Experiments on the TRECVID dataset demonstrate the effectiveness and efficiency of the proposed framework.

Some embodiments may jointly select both the samples and labels simultaneously. According to various embodiments, different labels of certain samples have different contributions to minimizing the expected classification error of the to-be-trained classifier. Annotating a well-selected portion of labels may provide sufficient information for learning the classifier.

Other possible active learning approaches can be seen as a one-dimension active selection approach, which only reduces the sample uncertainty. In contrast, the multi-label active learning disclosed herein is a two-dimensional active learning strategy, which may select the most “informative” sample-label pairs to reduce the uncertainty along the dimensionalities of both samples and labels. More specifically, along label dimension all of the labels correlatively interact. Therefore, once partial labels may be annotated, the concepts left unlabeled may then be inferred based on label correlations.

The approach disclosed herein may significantly save the labor cost for data labeling compared with fully annotating all labels. Thus, it is far more efficient when the number of labels is large. For instance, an image may be associated with thousands of concepts. That may mean a full annotation strategy may have a large labor cost for only one image. On the other hand, the online multi-label active learning disclosed herein may only manually annotate the most informative labels saving labor costs.

It is worth noting that during the online multi-label active learning process disclosed herein, some samples may lack some labels since only a partial batch of labels may be annotated. This is different from a traditional active learning approach. The missing labels for a certain sample may be seen as hidden variables and the corresponding classifier with such incomplete labeling may be trained by an Expectation-Maximum (EM) procedure accordingly.

Each sample x, may have m labels yᵢ (1≦i≦m) and each of them may indicate whether its corresponding semantic concept occurs. As stated before, in each active learning iteration, some of these labels may have already been annotated while others have not been. Let U(x)={i|(x, yᵢ) denote the set of indices of unlabeled part, and let L(x)={i|(x, yᵢ) denote the labeled part. Note that L(x) can be an empty set Ø, which indicates that no label has been annotated for x. Let P(y|x) is the conditional distribution over samples, where y={0, 1}m is the complete label vector and P(x) be the marginal sample distribution.

A large pool P of “pool-based” active learning may be available to the learner sampled from P(x) and the proposed active learning approach may then elaborately select a set of sample-label pairs from this pool to minimize the expected classification error. The expected Bayesian classification error is first expressed over all samples in P before selecting a sample-label pair (xₛ,yₛ)

$${ξ}^{b} ( P ) = \frac{1}{\vert P \vert} {\sum }_{x ∈ P} ξ ( y \vert {y}_{L ( x )} , x ) \qquad ( 1 )$$

The above classification error can be used on the pool to estimate the expected error over the full distribution P(x), i.e., E_{P(x)}ξ(y|y_{L(x)},x)=∫P(x)ξ(y|y_{L(x)},x)dx, because the pool not only provides a finite set of samples but also an estimation of P(x). After selecting the pair (xₛ, yₛ), the expected Bayesian classification error over the pool P is

$$\begin{matrix}{ξ}^{a} ( P ) = \frac{1}{\vert P \vert} \{ ξ ( y \vert {y}_{s} ; {y}_{L ( {x}_{s} )} , {x}_{s} ) + {\sum }_{x ∈ P \backslash {x}_{s}} ξ ( y \vert {y}_{L ( x )} , x ) \} \\ = \frac{1}{\vert P \vert} \{ ξ ( y \vert {y}_{s} ; {y}_{L ( {x}_{s} )} , {x}_{s} ) - ξ ( y \vert {y}_{L ( {x}_{s} )} , {x}_{s} ) \} + \\ {\sum }_{x ∈ P} ξ ( y \vert {y}_{L ( x )} , x )\end{matrix} \qquad ( 2 )$$

Therefore, the reduction of the expected Bayesian classification after selecting (xs, ys) over the whole pool P is

Δξ(P)=ξ^{b}(P)−ξ^{a}(P) (3)

Thus, in some examples, a most suitable sample-label pair (xₛ*, yₓ*) can be selected to maximize the above expected error reduction. That is,

$$\begin{matrix}( {x}_{s}^{*} , {y}_{s}^{*} ) = arg {max}_{{x}_{s} ∈ P , {y}_{s} ∈ U ( {x}_{s} )} Δξ ( P ) \\ = arg {min}_{{x}_{s} ∈ P , {y}_{s} ∈ U ( {x}_{s} )} - Δξ ( P )\end{matrix} \qquad ( 4 )$$

From the above:

$$- Δ ξ ( P ) = {ξ}^{a} ( P ) - {ξ}^{b} ( P ) \leq \frac{1}{\vert P \vert} \{ \begin{matrix}ɛ - \\ \frac{1}{2 m} {\sum }_{i = 1}^{m} MI ( {y}_{i} ; {y}_{s} \vert {y}_{L ( {x}_{s} )} , {x}_{s} )\end{matrix} \} \qquad ( 5 )$$

where MI(yᵢ;yₛ|y_{L(x}_{ₛ}₎,xₛ) is the mutual information between the random variables yᵢ and yₛ given the known label xₛ. Consequently, by minimizing the obtained error bound in Eqn. (5), we can select the sample-label pair for annotation as

$$\begin{matrix}( {x}_{s}^{*} , {y}_{s}^{*} ) = arg {min}_{{x}_{s} ∈ P , {y}_{s} ∈ U ( {x}_{s} )} \frac{1}{\vert P \vert} \\ \{ ɛ - \frac{1}{2 m} {\sum }_{i = 1}^{m} MI ( {y}_{i} ; {y}_{s} \vert {y}_{L ( {x}_{s} )} , {x}_{s} ) \} \\ = {arg max}_{{x}_{s} ∈ P , {y}_{s} ∈ U ( {x}_{s} )} {\sum }_{i = 1}^{m} MI ( {y}_{i} ; {y}_{s} \vert {y}_{L ( {x}_{s} )} , {x}_{s} ) \\ = {arg max}_{{x}_{s} ∈ P , {y}_{s} ∈ U ( {x}_{s} )} \\ \{ H ( {y}_{s} \vert {y}_{L ( {x}_{s} )} , {x}_{s} ) + {\sum }_{i = 1}^{m} MI ( {y}_{i} ; {y}_{s} \vert {y}_{L ( {x}_{s} )} , {x}_{s} ) \}\end{matrix} \qquad ( 6 )$$

As this multi-label active learning strategy exploits the redundancy along sample dimension and label dimension simultaneously, it may be referred to as Two-Dimensional Active Learning (2LAL). Single label active learning approaches may be referred to as One-Dimensional Active Learning (1LAL).

To attract average Internet users as online participants to label given data, various incentives may be used. For example, by providing attractive games. During game play the players may be asked to confirm labels of video clips with a friendly interface. Known games may be modified in accordance with various embodiments.

Online users may be paid for their participation. For example, they may be paid by the number of labeled sample-label pairs. The pay can be real currency or virtual currency which may be used to buy online products/content.

Another example incentive is to use CAPTCHA. CAPTCHA is a type of challenge-response test used to determine that the response is not generated by a computer. A typical CAPTCHA can include an image with distorted text which can only be recognized by human beings. This system, called reCAPTCHA, includes “solved” and “unrecognized” elements (such as images of text which were not successfully recognized via OCR) in each challenge. The respondent may thus answers both elements and roughly half of his or her effort validates the challenge while the other half is collected as useful information. This idea can also be applied to do image and video labeling.

In various embodiments one sample-label pair may be confirmed by multiple participants. Multiple confirmations may reduce labeling noise in that using online participants may yield lower quality labels compared with dedicated labelers.

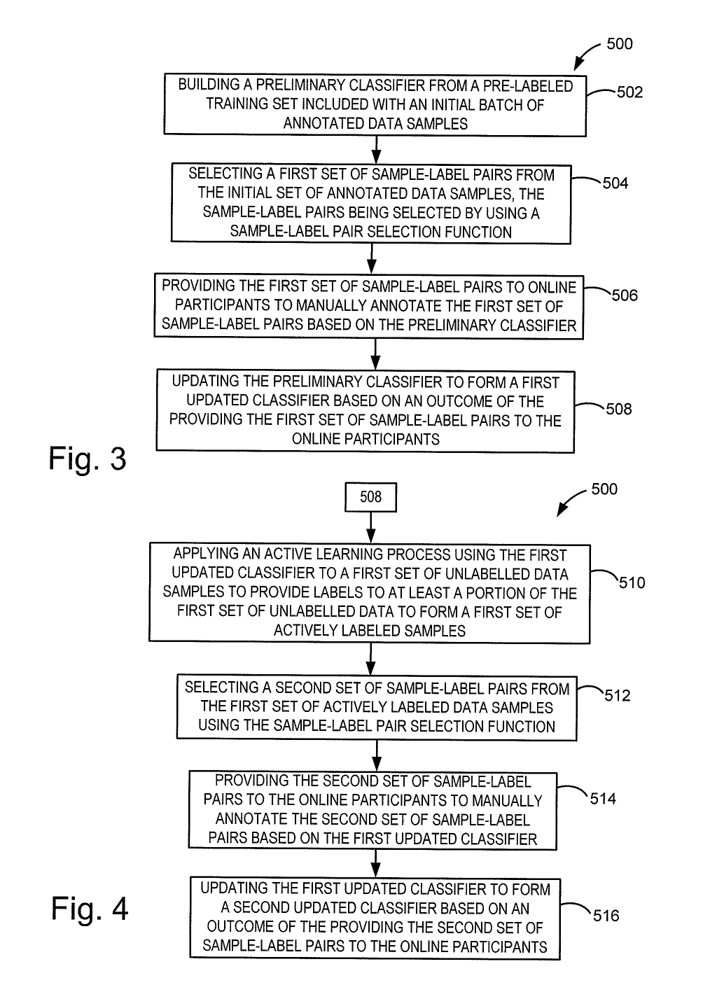

FIG. 3 is a flowchart illustrating an embodiment of a method 500 for annotating multiple data samples with multiple labels. The method 500 may be implemented via the components and systems described above, but alternatively may be implemented using other suitable components. The method 500 may include, at 502, building a preliminary classifier from an initial pre-labeled training set included with an initial batch of annotated data samples. The method 500 may also include, at 504, selecting a first batch of sample-label pairs from the initial batch of annotated data samples, the sample-label pairs being selected by using a sample-label pair selection module. The method 500 may also include, at 506, providing the first batch of sample-label pairs to online participants to manually annotate the first batch of sample-label pairs based on the preliminary classifier. In addition, the method 500 may include, at 508, updating the preliminary classifier to form a first updated classifier based on an outcome of the providing the first batch of sample-label pairs to the online participants.

FIG. 4 is a flow chart illustrating a variation of the method 500 illustrated in FIG. 3. The method 500 may further include, at 510, applying an active learning process using the first updated classifier to a first batch of unlabeled data samples to provide labels to at least a portion of the first batch of unlabeled data to form a first batch of actively labeled samples. The method 500 may include, at 512, selecting a second batch of sample-label pairs from the first batch of actively labeled data samples using the sample-label pair selection module. The method 500 may include, at 514, providing the second batch of sample-label pairs to the online participants to manually annotate the second batch of sample-label pairs based on the first updated classifier. The method 500 may also include, at 516, updating the first updated classifier to form a second updated classifier based on an outcome of the providing the second batch of sample-label pairs to the online participants.

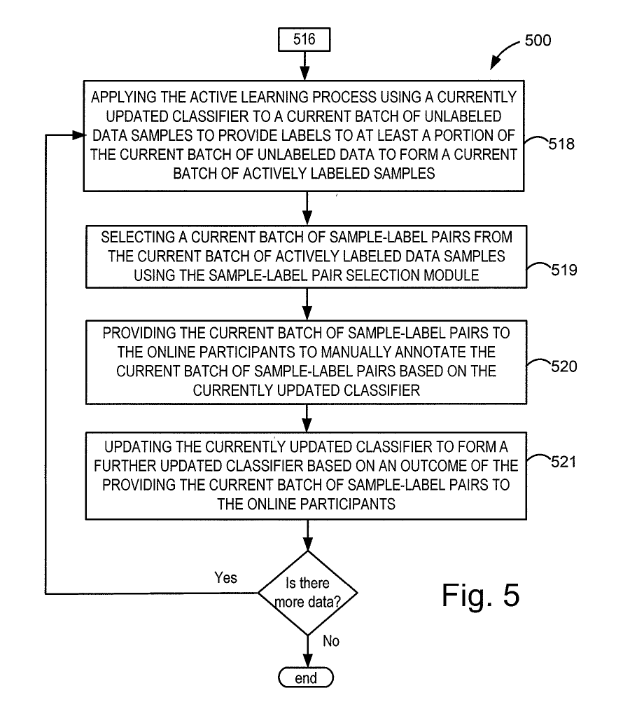

FIG. 5 is a flow chart illustrating a variation of the method 500 illustrated in FIG. 4. The method 500 may further include repeating, to increasing numbers of batches of data samples: at 518, applying an active learning process using a currently updated classifier to a current batch of data samples to provide labels to at least a portion of the current batch of unlabeled data to form a current batch of actively labeled samples; at 519, selecting a current batch of sample-label pairs from the current batch of actively labeled data samples using the sample-label pair selection module; at 520, providing the current batch of sample-label pairs to the online participants to manually annotate the current batch of sample-label pairs based on the currently updated classifier; and, at 521, updating the currently updated classifier to form a further updated classifier based on an outcome of the providing the current batch of sample-label pairs to the online participants.

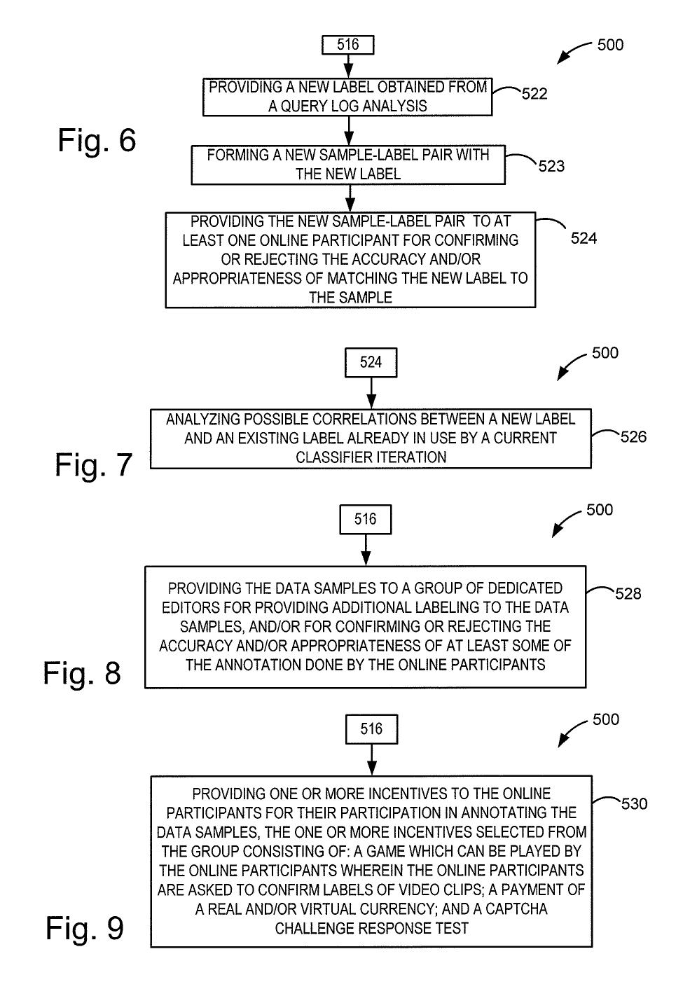

FIG. 6 is a flow chart illustrating a variation of the method 500 illustrated in FIG. 4. The method 500 may further include, at 522, providing a new label obtained from a query log analysis, and, at 523, forming a new sample-label pair with the new label, and, at 524, providing the new sample-label pair to at least one online participant for confirming or rejecting the accuracy and/or appropriateness of matching the new label to the sample.

FIG. 7 is a flow chart illustrating a variation of the method 500 illustrated in FIG. 6. The method 500 may further include, at 526, analyzing possible correlations between a new label and an existing label already in use by a current classifier iteration.

FIG. 8 is a flow chart illustrating a variation of the method 500 illustrated in FIG. 4. The method 500 may further include, at 528, providing the data samples to a group of dedicated editors for providing additional labeling to the data samples, and/or for confirming or rejecting the accuracy and/or appropriateness of at least some of the annotation done by the online participants.

FIG. 9 is a flow chart illustrating a variation of the method 500 illustrated in FIG. 4. The method 500 may further include, at 530, providing one or more incentives to the online participants for their participation in annotating the data samples, the one or more incentives selected from a group including: a game which can be played by the online participants wherein the online participants are asked to confirm labels of video clips; a payment of a real and/or virtual currency; and a CAPTCHA challenge response test.

The online participants may be instructed to manually confirm or reject the appropriateness of a match-up of the sample-label pair. The sample-label pair selection module may include minimizing an expected classification error from sample-label pairs (x*ₛ, y*ₛ) from a pool “P” of samples using the formula:

$$= arg {min}_{{x}_{s} ∈ P , {y}_{s} ∈ U ( {x}_{s} )} \frac{1}{\vert P \vert} \{ ɛ - \frac{1}{2 m} {\sum }_{i = 1}^{m} MI ( {y}_{i} ; {y}_{s} \vert {y}_{L ( {x}_{s} )} , {x}_{s} ) \}$$

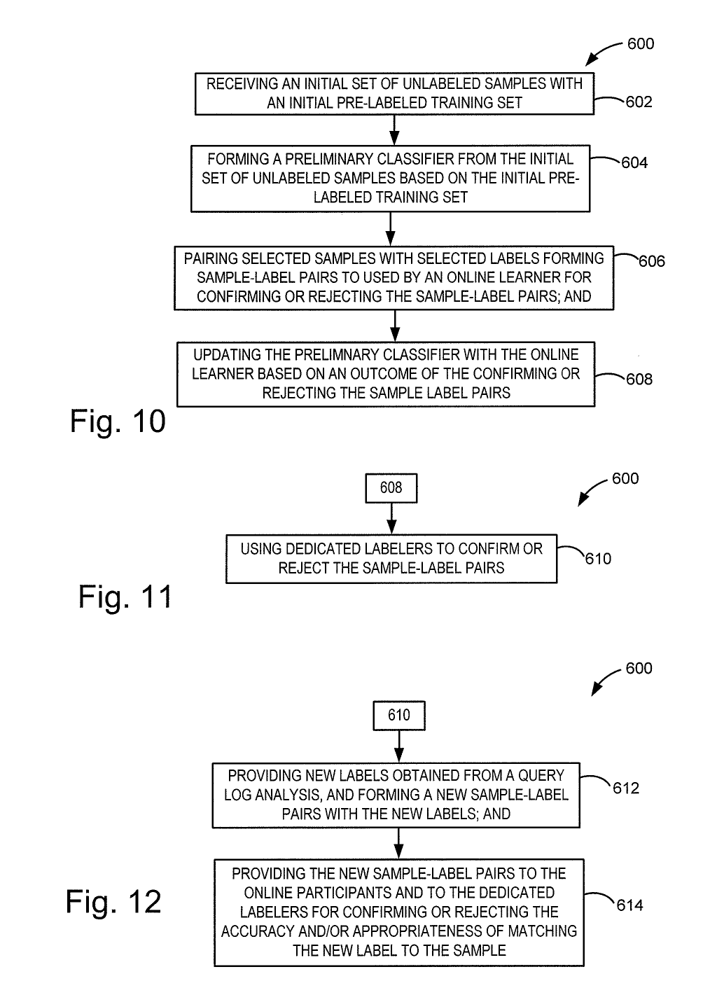

FIG. 10 is a flowchart illustrating an embodiment of a method 600 for online multi-label active annotation. The method 600 may be implemented via the components and systems described above, but alternatively may be implemented using other suitable components. The method 600 may include, at 602, receiving an initial batch of unlabeled samples with an initial pre-labeled training set. The method 600 may also include, at 604, forming a preliminary classifier from the initial batch of unlabeled samples based on the initial pre-labeled training set. The method 600 may also include, at 606, pairing selected samples with selected labels forming sample-label pairs to be used by an online learner for confirming or rejecting the sample-label pairs. The method 600 may also include, at 608, updating the preliminary classifier with the online learner based on an outcome of the confirming or rejecting the sample label pairs. The confirming or rejecting the sample-label pairs may be done manually by online participants.

FIG. 11 is a flow chart illustrating a variation of the method 600 illustrated in FIG. 10. The method 600 may also include, at 610, using dedicated labelers to confirm or reject the sample-label pairs.

FIG. 12 is a flow chart illustrating a variation of the method 600 illustrated in FIG. 11. The method 600 may further include, at 612, providing new labels obtained from a query log analysis and forming a new sample-label pairs with the new labels. The method 600 may also include, at 614, providing the new sample-label pairs to the online participants and to the dedicated labelers for confirming or rejecting the accuracy and/or appropriateness of matching the new label to the sample.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method for annotating multiple data samples with multiple labels, the method comprising:
building a preliminary classifier from a pre-labeled training set included with an initial batch of annotated data samples;
selecting a first batch of sample-label pairs from the initial batch of annotated data samples, the sample-label pairs being selected by using a sample-label pair selection module;
providing the first batch of sample-label pairs to online participants to manually annotate the first batch of sample-label pairs based on the preliminary classifier; and
updating the preliminary classifier to form a first updated classifier based on an outcome of the providing the first batch of sample-label pairs to the online participants.

2. The method of claim 1, further comprising:
applying an active learning process using the first updated classifier to a first batch of unlabeled data samples to provide labels to at least a portion of the first batch of unlabeled data samples to form a first batch of actively labeled samples;
selecting a second batch of sample-label pairs from the first batch of actively labeled data samples using the sample-label pair selection module;
providing the second batch of sample-label pairs to the online participants to manually annotate the second batch of sample-label pairs based on the first updated classifier; and
updating the first updated classifier to form a second updated classifier based on an outcome of the providing the second batch of sample-label pairs to the online participants.

3. The method of claim 2, further comprising iteratively repeating, to increasing numbers of batches of data samples:
applying an active learning process using a currently updated classifier to a current batch of unlabeled data samples to provide labels to at least a portion of the current batch of unlabeled data to form a current batch of actively labeled samples;
selecting a current batch of sample-label pairs from the current batch of actively labeled data samples using the sample-label pair selection module;
providing the current batch of sample-label pairs to the online participants to manually annotate the current batch of sample-label pairs based on the currently updated classifier; and
updating the currently updated classifier to form a further updated classifier based on an outcome of the providing the current batch of sample-label pairs to the online participants.

4. The method of claim 2, further comprising providing a new label obtained from a query log analysis, and forming a new sample-label pair with the new label, and providing the new sample-label pair to at least one online participant for confirming or rejecting the one or both of accuracy, and appropriateness of matching the new label to the sample.

5. The method of claim 4, further comprising analyzing possible correlations between a new label and an existing label already in use by a current classifier iteration.

6. The method of claim 2, further comprising providing the annotated data samples to a group of dedicated editors for providing additional labeling to the annotated data samples for confirming or rejecting one or both of an accuracy, and an appropriateness of at least some of the annotation done by the online participants.

7. The method of claim 2, further comprising providing one or more incentives to the online participants for their participation in annotating the data samples, the one or more incentives including a game which can be played by the online participants wherein the online participants are asked to confirm labels of video clips; a payment of a real or virtual currency; or a CAPTCHA challenge response test.

8. The method of claim 1, wherein the online participants are instructed to manually confirm or reject the appropriateness of a match-up of the sample-label pair.

9. The method of claim 1, wherein the sample-label pair selection module is configured to minimize an expected classification error from sample-label pairs (x*ₛ, y*ₛ) from a pool “P” of samples using a formula:
$$arg {min}_{{x}_{s} ∈ P , {y}_{s} ∈ U ( {x}_{s} )} \frac{1}{\vert P \vert} \{ ɛ - \frac{1}{2 m} {\sum }_{i = 1}^{m} MI ( {y}_{i} ; {y}_{s} \vert {y}_{L ( {x}_{s} )} , {x}_{s} ) \}$$

10. A system for multi-label active annotation of a collection of video samples including an initial batch of videos including an initial pre-labeled training set configured to be used to build a preliminary classifier, the system comprising:
an active annotation engine module including a sample-label pair selection module configured to select a first batch of sample-label pairs from the collection of video samples, and coupled with online participants to make the first batch of sample-label pairs available to the online participants to enable the online participants to provide feedback to the active annotation engine module confirming or rejecting an appropriateness of pairings of the sample-label pairs, the feedback configured to update the preliminary classifier to form an updated classifier such that the updated classifier is used to annotate subsequent batches of video samples.

11. The system of claim 10, wherein the active annotation engine module is further configured to iteratively select subsequent sample-label pairs from the subsequent batches of video samples, and to provide the subsequent sample-label pairs to the online participants to enable the online participants to provide feedback to the active annotation engine module confirming or rejecting an appropriateness of pairings of the subsequent sample-label pairs, the feedback configured to iteratively update the classifier to form a subsequently updated classifier such that the subsequently updated classifier is used to annotate subsequent batches of video samples.

12. The system of claim 10, wherein the preliminary classifier and the updated classifier are configured to provide automated annotation of the video samples.

13. The system of claim 10, further comprising a data connection between the active annotation engine module and one or more dedicated labelers and configured to enable the one or more dedicated labelers to one or both of provide additional annotation for the video samples, and confirm or reject one or both of the accuracy and appropriateness of at least some of the automatic annotation done using the updated classifier.

14. The system of claim 10, further comprising a query log module configured to capture query criteria from the online participants and configured to use the query criteria to create a new label to be used by the active annotation engine module.

15. The system of claim 14, further comprising a correlation module configured to compare the new label to other labels previously used to annotate the video samples, and further configured to use the new label only if a level of correlation between the new label and at least one previously used label is above a predetermined threshold.

16. The system of claim 10, wherein the sample-label pair selection module is configured to minimize an expected classification error from sample-label pairs (x*ₛ, y*ₛ) from a pool “P” of samples using the formula:
$$arg {min}_{{x}_{s} ∈ P , {y}_{s} ∈ U ( {x}_{s} )} \frac{1}{\vert P \vert} \{ ɛ - \frac{1}{2 m} {\sum }_{i = 1}^{m} MI ( {y}_{i} ; {y}_{s} \vert {y}_{L ( {x}_{s} )} , {x}_{s} ) \}$$

17. A method for multi-label active annotation, the method comprising:
receiving an initial batch of unlabeled samples with an initial pre-labeled training set;
forming a preliminary classifier from the initial batch of unlabeled samples based on the initial pre-labeled training set;
pairing selected samples with selected labels forming sample-label pairs to be used by an online learner for confirming or rejecting the sample-label pairs; and
updating the preliminary classifier with the online learner based on an outcome of the confirming or rejecting the sample label pairs.

18. The method of claim 19, wherein the confirming or rejecting the sample-label pairs is done manually by online participants.

19. The method of claim 18, further comprising using dedicated labelers to confirm or reject the sample-label pairs.

20. The method of claim 19, further comprising providing new labels obtained from a query log analysis, and forming new sample-label pairs with the new labels, and providing the new sample-label pairs to the online participants or dedicated labelers for confirming or rejecting one or both of an accuracy, and an appropriateness of matching the new label to the sample.
